(19) United States
(12) Patent Application Publication
(10) Pub. No.: US 2012/0033212 A1
(43) Pub. Date: Feb. 9, 2012

(54) LASER INDUCED BREAKDOWN SPECTROSCOPY INSTRUMENTATION FOR REAL-TIME ELEMENTAL ANALYSIS

(75) Inventor: James E. Barefield, II, White Rock, NM (US)

(73) Assignee: Los Alamos National Security, LLC, Los Alamos, NM (US)

(21) Appl. No.: 13/180,321

(22) Filed: Jul. 11, 2011

Related U.S. Application Data
(60) Provisional application No. 61/363,130, filed on Jul. 9, 2010.

(51) Int. Cl. G01J 3/32

(52) U.S. Cl. 356/318

(57) ABSTRACT

A backpack laser-induced breakdown spectroscopy LIBS system to provide rapid in-field elemental analysis of environmental samples important to the safeguarding of special nuclear materials.

### CROSS-REFERENCE TO RELATED APPLICATIONS

The present application claims the benefit of U.S. Provisional Patent Application No. 61/363,130, which was filed on Jul. 9, 2010, the entire contents of which is hereby specifically incorporated by reference herein for all that it discloses and teaches.

### STATEMENT REGARDING FEDERAL RIGHTS

This invention was made with government support under Contract No. DE-AC 52-06 NA 25396, awarded by the U.S. Department of Energy. The Government has certain rights in this invention.

### FIELD OF THE INVENTION

The invention concerns in general the technology of laser-induced breakdown spectroscopy. In particular the invention concerns the structure of an apparatus built for laser-induced breakdown spectroscopy measurements.

### BACKGROUND OF THE INVENTION

For various applications, methods are needed for determining the material constitution of a sample. One of known methods is laser-induced breakdown spectroscopy (LIBS), which involves focusing a laser beam onto a surface of the sample with a high enough power density to transform a small part of the sample material into a state of plasma. Optical emissions from the plasma plume are collected with light collection optics, and the spectral distribution (i.e. intensity as a function of wavelength) of the collected optical emissions is analysed in a spectrometer that produces information in electronic form describing the spectral distribution. Since atomic and molecular constituents of sample materials have characteristic optical emission spectra, the information produced by the spectrometer forms a kind of a fingerprint of the sample material, revealing the constituents of that part of the sample onto which the laser beam was focused.

The primary tool employed by the IAEA (“International Atomic Energy Agency ”) to detect undeclared processes and activities at special nuclear material facilities and sites is environmental sampling. The development of advanced tools and methodologies to detect and analyze undeclared processing or production of special nuclear material is currently required. The present invention fills this need by providing a (1) a user-friendly man-portable LIBS system to characterize samples in real to near-real time (typical analysis time are on the order of minutes) across a wide range of elements in the periodic table from hydrogen up to heavy elements like plutonium and uranium, (2) a LIBS system that can be deployed in harsh environments such as hot cells and glove boxes providing relative compositional analysis of process streams for example ratios like Cm/Up and Cm/U, (3) an inspector field deployable system that can be used to analyze the elemental composition of microscopic quantities of samples containing plutonium and uranium, and (4) a high resolution LIBS system that can be used to determine the isotopic composition of samples containing for example uranium and plutonium.

Laser Induced Breakdown Spectroscopy (LIBS) is a laser based optical method that can be used to determine the elemental composition of liquids, solids, and gases. In the LIBS technique, short pulses (typically 10 nanoseconds) from a laser are focused upon the surface of a sample where a micro-plasma is generated consisting of elements evolved from the surface and the gas above the surface. The emission from the plasma is wavelength resolved and detected using a dispersive device and a detector. The resulting spectrum is analyzed with a computer. The emission spectrum is characteristic of the emitting species in the plasma which are typically atoms, ions, and small molecules. If the spectra are collected and analyzed as a function of the chemical composition of the elements present, calibration curves can be generated from which semi to quantitative information can be determined. LIBS offer several advantages over classical wet chemical analysis techniques; (1) real-time or near real time automated elemental analysis, (2) it is essentially non-destructive with little or no sample preparation and handling required, and (3) all the elements in the periodic table can be analyzed from hydrogen to heavy elements like the actinides. It is also a highly configurable technique meaning that instruments of many different shapes, sizes, and configurations can be designed, constructed, tested, and used to obtain chemical compositional information with varying levels of sensitivity, precision, and deployment (from fixed lab to field deployable systems). The accuracy of LIBS measurements is typically better than 10% and precision is often better than 5%. The detection limits for LIBS vary from one element to the next depending on the specimen type (matrix), the experimental apparatus used, and experimental conditions under which desired measurements are made. Even so detection limits of 1 to 30 ppm by mass are not uncommon, but can range from less than 1 ppm to ten's of ppm.

Conceptually, the instrumentation for LIBS can range from simple to complex, depending upon the analytical analysis protocol and the level of precision and accuracy of the desired measurement. A schematic of a LIBS instrument is shown in FIG. 1. In this diagram, the output typically from a Nd:YAG laser is focused onto the surface of a sample where a small plasma (typically a few millimeters is generated. The laser operates at 1064 nanometers with a pulse length of 7-10 nanoseconds. Depending upon the coupling of the laser light to the sample, 10 to several hundred milijoules of excitation energy is required to generate the plasma. The emission is collected with a lens and directed to a monochromator using a fiber optic bundle. The emission is then analyzed by a computer.

The backpack LIBS system was designed to provide rapid in-field elemental analysis of environmental samples important to the safeguarding of special nuclear materials. Currently, environmental elemental analysis is performed by collection, packaging, and shipping of samples to an approved analytical laboratory for analysis. This practice can take days and months if not longer to complete and is also costly especially if some of the samples are potentially contaminated with actinide elements. The backpack LIBS system was designed to be user friendly with several integrated safety features making the system safe to operate under normal conditions. This is a Class IV embedded laser system but because safety interlock features both software and hardware has been integrated into the system, no laser safety eyewear is required.

Depending upon the intended use and analysis scenario most analyses can be completed in a matter of minutes. The complete system is operated from battery power in a standalone mode and weighs approximately 25 pounds. The nominal operational lifetime of the backpack LIBS system is approximately 3.5 hour starting with a fully charged battery.

### BRIEF DESCRIPTION OF THE DRAWINGS

FIG. 1 shows a schematic of a typical LIBS system;

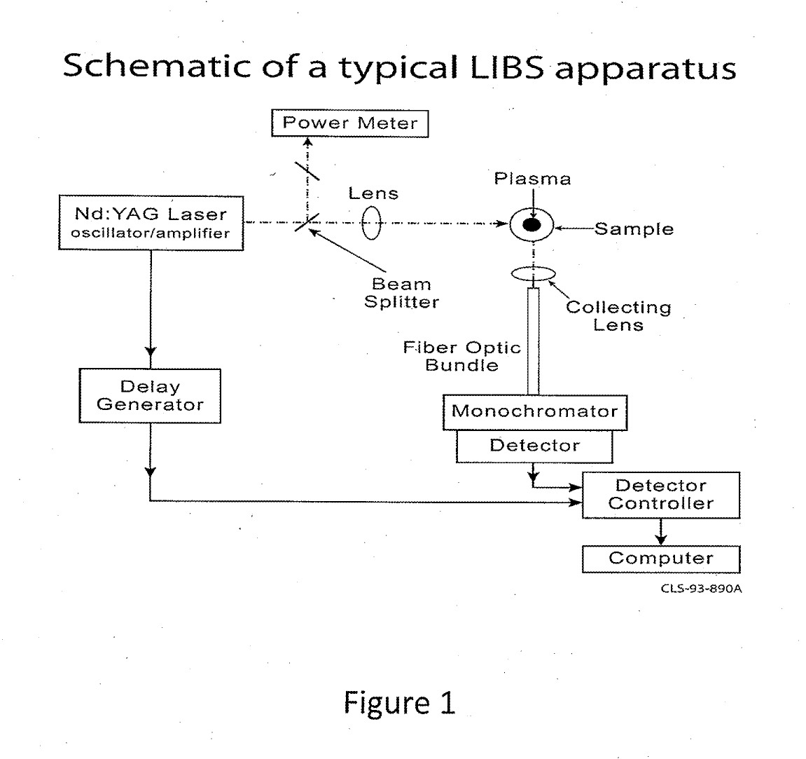

FIG. 2 shows a picture of the backpack system is being worn by a user. On the right hand side is a typical LIBS spectrum of an aluminum alloy (Al 7075) sample in the region 200-420 nanometers (nm);

FIG. 3 shows the MVA analysis of LIBS spectra for samples listed above showing clustering according to sample type on the left hand side. On the right hand side MVA analysis is shown for only the samples containing Fe;

FIG. 4 shows a low resolution spectrum of a 304 stainless steel sample;

FIG. 5 shows a low resolution LIBS spectrum of a sample of natural abundance uranium ore between 200 and 420 nm.

FIG. 6 shows a general view of the Cart/Rack mounted LIBS system on the left and the system coupled to a 50 meter fiber optic cable illuminated with a green alignment laser for visual effects.

FIG. 7 shows high resolution sections of a 316 stainless steel sample collected through a 2 meter fiber cable. On the left hand side is a broad view of the spectrum covering approximately 300 nanometers. On the right hand side is a 5 nm section showing very good signal to noise.

FIG. 8 shows sections of LIBS spectra of a 316 stainless steel sample collected through a 50 meter fiber optic cable.

### DETAILED DESCRIPTION OF THE INVENTION

The foregoing description of the invention has been presented for purposes of illustration and description and is not intended to be exhaustive or to limit the invention to the precise form disclosed, and obviously many modifications and variations are possible in light of the above teaching.

A backpack mounted portable LIBS system has been developed for the detection of the presence of actinides and other elements important to international safeguards. In one embodiment the system consists of a small Nd:YAG laser operating at ⅓ Hz with an output energy of 25 mj/pulse. The emission from the plasma is collected and directed to at least one spectrometers, using optical fibers. The spectra are detected with a CCD detector and analyzed with a pocket computer. The combined system weighs approximately 25 pounds; however different embodiments of the backpack may weigh as little as 12 pounds.

Table 1 lists the components of one embodiment of the present invention.

TABLE 1
System Components and Specifications

| | |
|---|---|
| 1. | Laser (Kigre, Inc.), nominal output 25 mj/pulse single shot, pulse |
| | width 4 ns, beam diameter 3 mm, beam divergence 90% |
| | less than 1 mr, rep rate 0.3 Hz, lifetime >300,000 shots |
| 2. | Spectrometers 3 (Ocean Optics), HR2000+, spectral ranges S1 |
| | (200-400 nm), S2 (400-600 nm), S3 (600-1000 nm), 2 MHz A/D |
| | converter, programmable electronics, a 2048 element CCD-array |
| | detector, high speed USB 2.0 port, spectral resolution approximately |
| | 0.35 nm (FWHM) |
| 3. | Four port USB Hub (D-link@ 4-Port USB 2.0 Hub (HuB-H-4)) |
| 4. | Digital delay generator (Highland Technology), 4 pulse outputs, |
| | 5 V each, programmable for delay, width, and polarity, delay range |
| | 0 to 10 seconds, 10 ps resolution, and width range 2 ns to 10 seconds, |
| | 10 ps resolution, trigger rate 0 to 16 MHz |
| 5. | Computer (Sony, Vaio P Series VGN-P699 E/Q), 533 MHz CPU, |
| | memory 2 GB, 256 GB Hard Drive |
| 6. | Collection fibers (Ocean Optics) trifurcated, 2 meters in length, |
| | one UV solarized, 2 VIS/NIR, 600 micron core diameter |
| 7. | Focusing lens (CVI Optics) 3.5 inch focal length |
| 8. | A power distribution system used to supply power to all of the |
| | electronic components in the electronic control unit and safety |
| | interlock systems |

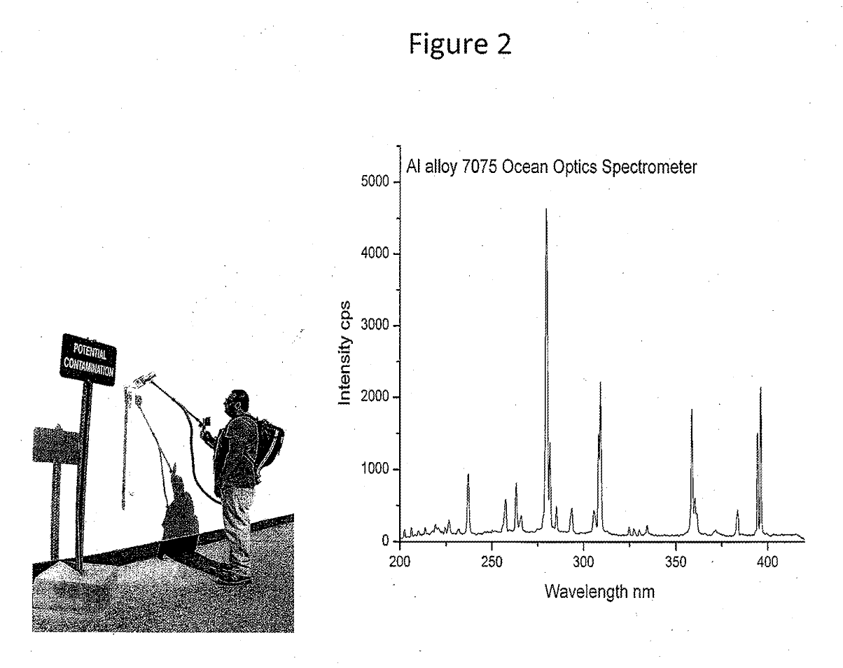

A picture of the backpack LIBS system is shown in FIG. 2. The green/silver unit at the end of the probe and near the wall is the sampling head that includes the small laser and focusing optics used to generate the plasma. The black umbilical cord contains fiber optic cables for collecting emission from the plasma and directing it to the spectrometers and power cables for supplying power to the laser. A pocket PC is located near the user's right hand that services as the master controller for the laser, electronics, spectral collection, and data analysis. The backpack contains the laser power supply, Ocean Optics spectrometers, and associated electronics for controlling the system.

In one example, the system described above was used to analyze the following samples: (1) Magnets, AlNiCo, SmCo, and NdFeB; (2) Steels, 350 Marging steel, 250 marging steel, 304L SS, 316 SS, and A36 HRS (hot rolled steel); (3) Aluminum alloys, 6061 Al, 7075 Al, and 2024 Al; (4) Carbon fiber or graphite; (5) Aramid rubber; and (6) naturally abundance uranium in SRM 610 (standard reference material from NIST, Washington, D.C., USA) and uranium ore. The concentration of uranium in the SRM and uranium ore samples was approximately 450 and 7500 ppm respectively.

Multivariate analysis or MVA was used to analyze spectral data collected from the samples listed above. The spectra collected and analyzed are similar to that shown in FIG. 2 for Al 7075.

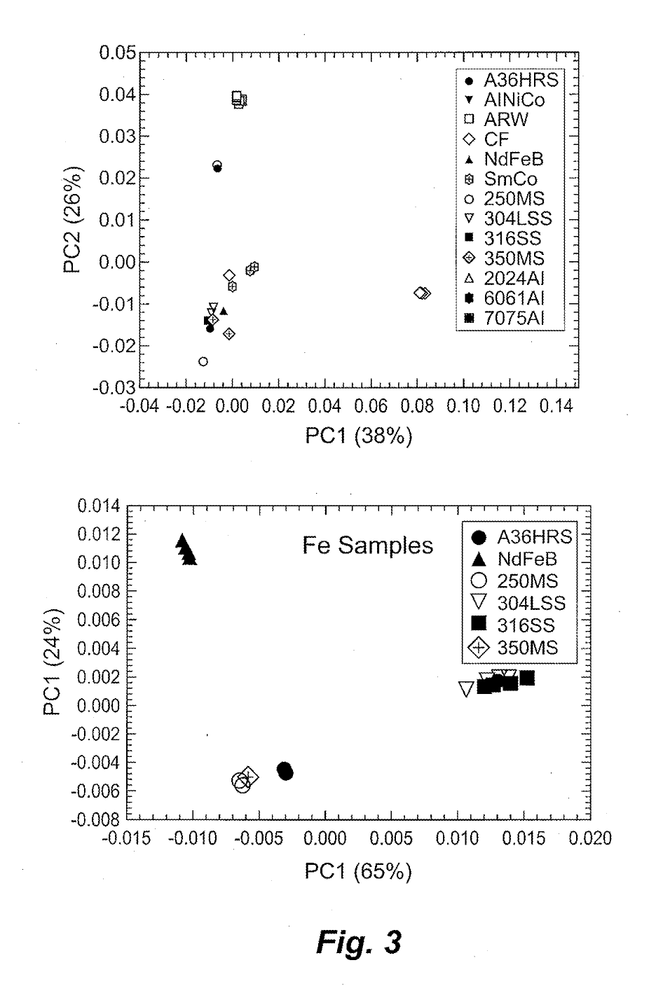

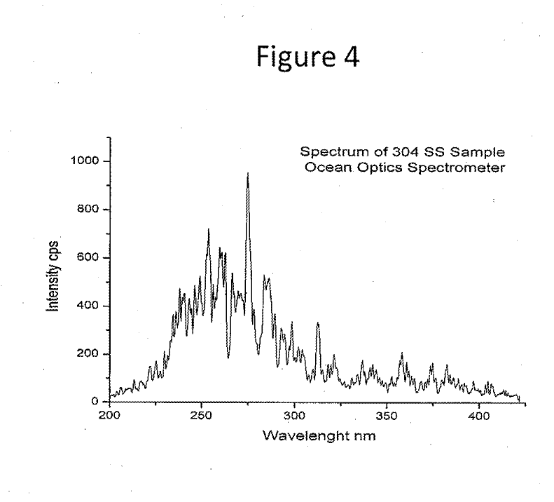

The data presented in FIG. 3 indicates that MVA analysis of LIBS data can be used to classify samples of similar types. There is clustering of the samples when a wide range of sample types are used in the analysis. When only the samples containing Fe are analyzed, there is further clustering of different sample types but the concentration of the trace elements are too close to effect a significant separation for the stainless and the marging steel samples. A significant issue in this type of analysis is the low resolution (approximately 2000-3000) of the spectral data acquired with the Ocean Optic spectrometers. An example of a spectrum of a 304 stainless steel sample is shown in FIG. 4. There is significant overlap between the complex spectral signatures of Fe and the trace elements. The spectral signatures for the aluminum alloy sample shown in FIG. 2 are much less congested or are reasonably well separated allowing for more accurate assignments.

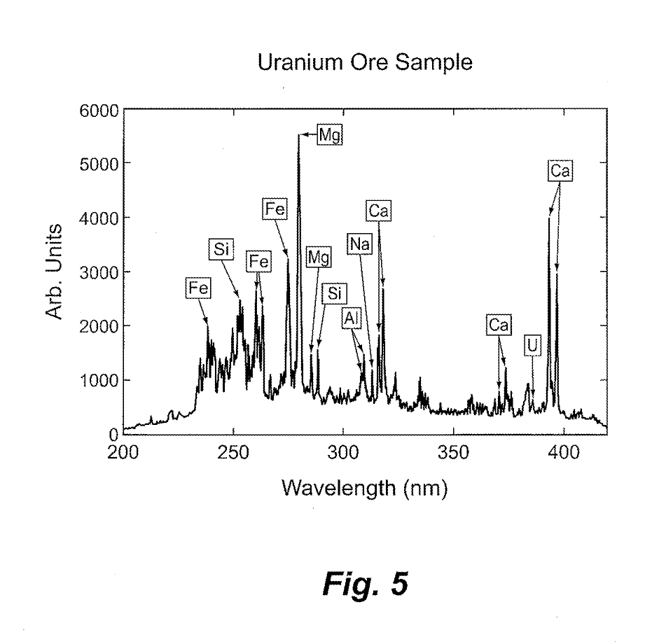

The system has also been used to obtain LIBS spectra from samples of natural abundance uranium in different matrices (uranium ore, KBr pellets, and standard reference materials (SRM from NIST)). A typical low resolution LIBS spectrum of a natural abundance uranium ore sample is shown in FIG. 5 between 200 and 420 nanometers along with some preliminary assignments. The most intense peaks assigned in the spectrum shown in FIG. 5 above are not due to uranium transitions. The uranium ore sample or BL-5 is a low grade concentrate from Beaverlodge, Saskatchewan, Canada. The major mineralogical components are, in decreasing order of abundance: plagioclase feldspar (Na₆₅K₁₀Ca₂₅), hematite (Fe₂O₃), quartz (SiO₂), calcite (CaCO₃), dolomite (CaMg(CO₃)₂), chlorite ((Mg,Fe,Al)₃(Si,Al)₄O₁₀(OH)₂(Mg,Fe,Al)₃(OH)₆), and muscovite (KAl₂AlSi₃O₁₀(OH,F)₂); uraninite (UO₂) is the main uranium-bearing mineral. The approximate chemical composition of the major elements in this standard sample in weight percent are: Si (22.0), U (7.09), Al (6.0), Fe (5.9), Ca (4.0), Na (3.6), C (1.9), Pb (1.5), Mg (1.5), K (0.4), Ti (0.4), S (0.3) and V (0.1). The density of states for uranium and other actinides is very high compared to elements like calcium, iron, magnesium, silicon, aluminum, and sodium. In the case of uranium in the sample, the excitation energy must be shared among the high density of states that are available for emission. Thus electronic transitions involving such states are generally weak when present with other elements with less complicated electronic state distributions. This along with the more complicated quantum physics and photo-dynamics associated with emission from excited states in actinide elements makes analysis very challenging using LIBS.

However, several low resolution analysis peaks have been analyzed that can be used to detect the presence of uranium in environmental samples. The peaks that have been identified and assigned for uranium are listed in Table 2 where I and II refer to the neutral and first ionized excited electronic states of uranium atoms.

TABLE 2
Preliminary Uranium peak Assignments

| Wavelength nm | Ionization State |
|---|---|
| 268.37 | U II |
| 270.63 | U II |
| 277.00 | U II |
| 278.44 | U II |
| 295.63 | U II |
| 302.22 | U II |
| 310.24 | U II |
| 311.16 | U II |
| 339.47 | U II |
| 350.76 | U I |
| 353.4 | U II |
| 367.01 | U II |
| 385.9 | U II |
| 387.4 | U II |
| 389.4 | U II |
| 399.82 | U II |
| 401.78 | U II |
| 409.19 | U II |
| 411.61 | U II |
| 415.4 | U II |
| 424.3 | U II |
| 436.1 | U I |
| 462.7 | U II |
| 547.5 | U II |
| 548.01 | U II |
| 556.4 | U II |
| 597.6 | U I |
| 682.8 | U I |

The present system can be operated in a completely stand-alone mode for approximately 1.5 hours using battery power and a different embodiment with a more efficient and compact battery power system increases the operational analysis lifetime to approximately 3 hours and reduces the overall weight to approximately 15 pounds. Transparent automatic user friendly analytical analysis functionality is also being integrated into this system.

An additional embodiment includes a high resolution LIBS system that includes a high resolution echelle spectrograph (for example a spectrograph made by LLA Instruments, Berlin, Germany). The high resolution spectrograph has a resolution of approximately 20,000 (wavelength/shift in wavelength). The emission is detected with an ICCD detector within the spectral range of 200 to 780 nm. The excitation source is a Quantel Nd:YAG laser operating at 20 Hz and with a 9 nanosecond pulse width and maximum output energy of 100 mj/pulse. The system is controlled by an industrial computer operating on the windows XP platform. This system has the capability to be operated in one of three modes: (1) In situ with measurements distances of a few inches in a sampling chamber attached to a mobile platform; (2) remote measurements using direct optical access through the containment windows of hotcells or gloveboxes using a variable focusing head; and (3) remote measurements using fiber optic coupled probes at measurement distances up to approximately 100 meters both inside and outside hotcells and gloveboxes.

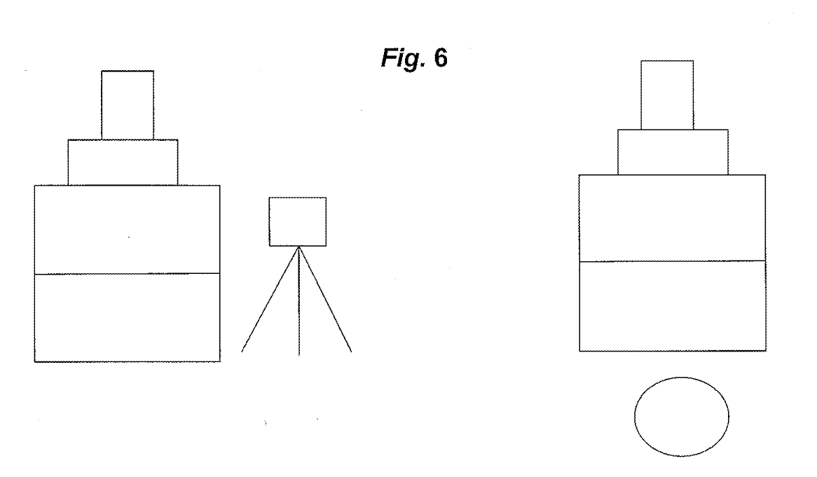

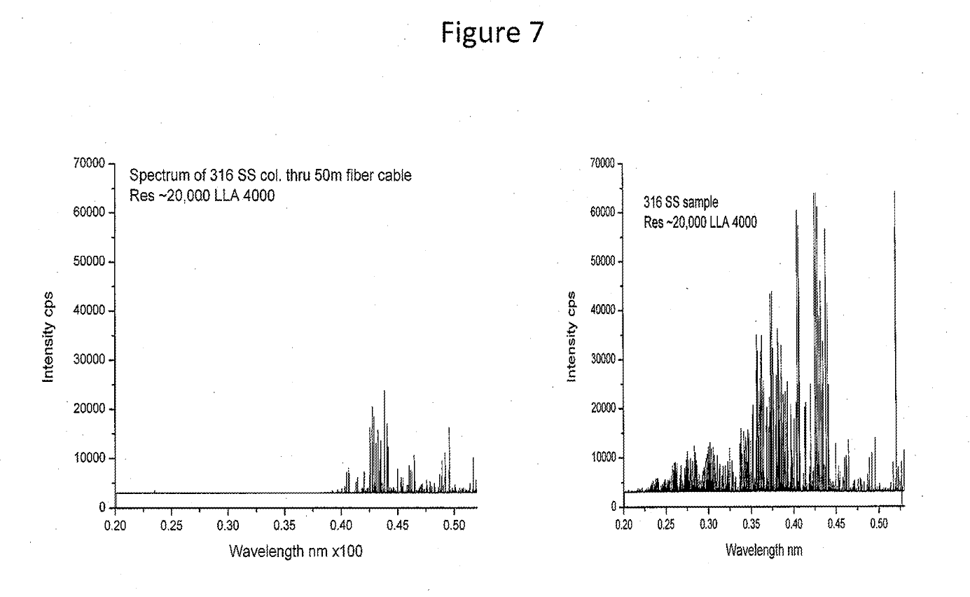

The remote functionality of this system in principle allows monitoring and control of nuclear materials and processes at nuclear facilities in real to near-real time in a continuous and un-attended mode. Therefore any attempt to clandestinely remove or modify materials and nuclear facilities will be immediately detected. This system also can be used to provide isotopic and ratio analysis of samples of actinides (for example, isotopic measurements on samples of uranium, and important ratios that include U/Cm, Pu/, Cm, etc). One embodiment of this system is shown in FIG. 6. The picture on the left shows the sampling head (blue box mounted on a tripod) that contains the laser excitation source and optics for directing and focusing the laser beam through a window of a hotcell or glovebox. The sampling head also includes optics for collecting the emission from the plasma and directing it to the spectrograph (black box to the left of the first level below the top of the platform) via a fiber optic cable. The blue box on the top of the platform with the access door open is the in situ sampling chamber. The light beige box also located on the first shelf below the top is the industrial computer used to control the system. The vertical light colored box on the bottom shelf is the power supply for the Nd:YAG laser. The picture on the right side of FIG. 6 shows the system coupled to a 50 meter fiber optic cable that was illuminated with a green alignment laser for visual effects. This system has been used to collect LIBS spectra through 2, 5, 20, and 50 lengths of fiber optic cables. A typical LIBS spectrum collected from a sample of 316 stainless steel is shown in FIG. 7. This type of spectra can be used to determine elemental ratios of samples of special nuclear material. By contrast, it would be very difficult to use the low resolution spectra shown in FIG. 4 (spectrum of a sample of 304 stainless steel), acquired with an Ocean Optics spectrometer to perform elemental ratio analysis of complex elements like the actinides.

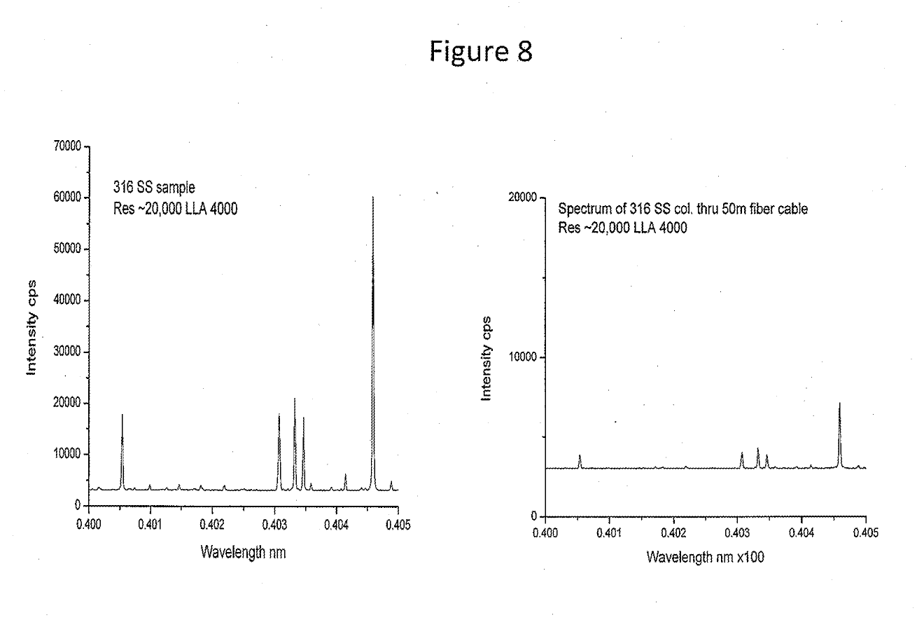

Spectra of a 316 stainless steel sample collected through a 50 meter 800 micrometer core diameter fused silica fiber with silicon cladding is shown in FIG. 8. Data from the initial performance testing of the Cart/Rack mounted high resolution LIBS system indicates that the system is working very well for the in situ sample chamber configuration.

In one embodiment, LIBS analysis is carried out using the following sequence. Initially the operator is required to perform a system check to verify that the portable LIBS unit is operational. Once the system check is complete, the software will open the setup analysis window to set the number of shots to average per scan. At this point the acquire data button will be enabled to measure the spectral emission. The data can then be saved using the save data function. Samples can be identified from a known library using the identify sample function. The known library is a database which contains spectral data for a variety of materials. If the material is not contained in the library, it will identify as “unknown” and be added to the library.

LIBS analysis is preformed using the following seven steps: (1) Start Up, (2) System Check, (3) Setup Analysis, (4) Acquire Data, (5) Save Data, (6) Identify Sample, and (7) Shutdown. The steps are followed to identify the sample(s) or perform analysis as desired.
Start Up—To begin analysis, a LabVIEW program is run. The program initially checks for devices (the laser interlock via the digital I/O, digital delay generator, and spectrometers). When all devices are found, the round Ready LED on top right will turn green while the bottom square LEDs will change colors accordingly to indicate which devices are detected
System Check—It is required that the system check and setup analysis tasks be completed at least once prior to performing an analysis. The acquire data function can then be repeated to obtain spectral measurements. Once the measured spectra are available, both save data and identify sample functions will be enabled. At this point, the operator can save the spectral data and identify a sample by comparing the measured to the known spectra if desired. The System check contains a selection of 3 standards: cadmium, copper, and aluminum 6061. A user places the standard under the sampling head before pressing the corresponding standard button in the System check window. After pressing the named sample button in the System check window, the Standard check panel will become visible. The known spectrum of the selected standard is displayed before emission is collected from five laser shots. The average of the emission spectra is then overlayed. Once the spectral data is matched with the known spectra for each check standard, the user can proceed to the set up analysis functional button to begin sample analysis.
Setup Analysis—When the setup analysis function is activated in the main the user has the option to modify the number of laser shots per sampling analysis. The default is the five-shot scan but other options may be used.
Acquire Data—The spectral data plot is displayed. In the spectral data plot, the relative intensity is on the vertical axis whereas the wavelength (in nanometers) is located on the horizontal axis. The acquire data task can be repeated as many times as desired, only after both system check and setup analysis are successfully completed at least once. When the operator is satisfied with the quality of the spectra, he/she may choose to save the spectra and to identify the sample.
Save Data—Five files will be generated during this step: four are spectral data (zz=UV, VIS, NIR, ALL) and the fifth file (zz=COM) stores the LIBS analysis operating parameters.
Identify Sample—This produces a list of sample names which will include the best matches within 90% margin of the highest match.
Shutdown—This is usually done at the end of LIBS analysis or when swapping out the battery in the electronic control unit inside the backpack.

As described above, the LIBS system of the present invention is designed to address the needs of the IAEA inspectors, the goals of DOE/NNSA's NGSI, and International Safeguards. The goals and needs are supported by providing (1) improvements in the analysis times for special nuclear materials (typical analysis times on the order minutes can be achieved), (2) performing real-time process monitoring and control in nuclear facilities in a continuous and unattended mode, and (3) performing in-field, prescreening and analysis of environmental and nuclear material samples. The backpack LIBS system can be used to provide real time analysis in the field thereby significantly reducing the number and therefore the cost associated with the collection, packaging, and shipping of samples for further analysis. The burden and sample loading on analytical labs like the safeguards analytical lab will also be significantly reduced as well. Combining LIBS with fiber optic probes from multiple locations within nuclear material processing facilities has the potential for process monitoring and control in a continuous and unattended fashion. Thus any clandestine attempt to divert or remove material from nuclear facilities will be reduced.

What is claimed is:

1. An apparatus for measuring the contents of an analysis sample, comprising:
(a) a pulsed laser energy emitter;
(b) an optical transmission medium for focusing energy from said pulsed laser energy emitter onto said analysis sample, for generating a plasma state in a portion of said analysis sample; and
(c) a detector for measuring spectral characteristics of energy emitted from said analysis sample when exposed to focused energy, wherein the apparatus is portable.

2. The apparatus of claim 1 wherein the weight of the apparatus is no more than 25 pounds.

3. The apparatus of claim 1 wherein the apparatus is a backpack.

4. The apparatus of claim 1 further comprising a high resolution spectrograph.

5. A method for measuring the content of an analysis sample comprising the steps of:
(a) emitting laser pulses from a pulsed laser energy emitter;
(b) focusing energy from said pulsed laser energy emitter on said analysis sample, thereby generating a plasma state in a portion of said analysis sample;
(c) measuring spectral characteristics of energy emitted from said analysis sample when exposed to focused energy; and
(d) detecting elements in said analysis sample by the presence of narrow spectral line characteristics, wherein the method is completed in real-time.

6. The method of claim 5, further comprising the step of comparing the spectral characteristics to a known database containing spectral characteristic of a variety of materials.

7. The method of claim 5, wherein the measurements of the spectral characteristics are made remotely.
